(19) United States
(12) Patent Application Publication
(10) Pub. No.: US 2010/0125388 A1
(43) Pub. Date: May 20, 2010

(54) INFORMATION WRITING TOOL AND SYSTEM

(75) Inventor: Hideharu Nagatomo, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/617,964

(22) Filed: Nov. 13, 2009

(30) Foreign Application Priority Data
Nov. 18, 2008 (JP) 2008-294493

(51) Int. Cl. G06F 19/00

(52) U.S. Cl. 701/36

(57) ABSTRACT

An ECU having a vehicle connector is coupled with an information writing tool that stores vehicle information specifically associated with corresponding vehicle specification, when the ECU is repaired or replaced. By connecting, to the vehicle connector of the ECU in a one-to-one correspondence manner, a tool connector of the information writing tool having specific vehicle information, which varies depending on vehicle types and shipping destinations, the specific vehicle information can be securely transferred and written to a vehicle memory in the ECU from a tool memory in the information writing tool without elaborate inventory control, even when the combination variations yielded from various vehicle types and shipping destinations are enormous.

### CROSS REFERENCE TO RELATED APPLICATION

The present application is based on and claims the benefit of priority of Japanese Patent Application No. 2008-294493, filed on Nov. 18, 2008, the disclosure of which is incorporated herein by reference.

### FIELD OF THE INVENTION

The present disclosure generally relates to a vehicle information writing system, which employs a vehicle information writing tool.

### BACKGROUND INFORMATION

Japanese patent documents Laid-Open No. 2003-337748 (US publication of No. 20030221049), No. 2003-172199, and No. 2001-229014 are referenced in the following description.

In recent years, vehicles use electric control units, a so-called ECU, for controlling various devices and equipments disposed therein. The ECUs are disposed in the vehicle, and perform various processes for controlling devices and equipments in the vehicle, based on software executed by a microprocessor in respective ECUs. The software in the ECUs is updated at times, for accommodating version-ups, bug-correction, and the like. Therefore, the software in the ECUs is stored in a non-volatile memory such as a flash memory or the like. Refer to the three patent documents listed above, for example. Further, for accommodating various process contents depending on the vehicle types and vehicle specifications, vehicle information representing each of those vehicle types and vehicle specifications is also stored in the non-volatile memory for reference purposes. The software refers to the vehicle information in the non-volatile memory for realizing a vehicle specification that is specific for each of the various destination areas and/or countries. That is, vehicle information is changed for country to country, area to area, for accommodation of various vehicle types and for conformity to regulations in the destination countries. For example, for the vehicles used in cold districts, cold districts specification is arranged, and the vehicle information for use in the cold districts vehicle reflects the cold districts specification.

The ECU as a part of the vehicle components is replaced with a new one, when the ECU is diagnosed to be suffering from irreparable trouble. That is, for example, after the vehicle is brought to a dealer and is diagnosed to be broken, the ECU is replaced with a new one (i.e., a supplemental ECU) when the trouble of the relevant function is identified as caused by the ECU by checking the vehicle maintenance history or the like.

When the ECU is replaced with a new one, a mechanic in the dealer checks a part number of the supplemental ECU based on the vehicle type/specification, places an order of the supplemental ECU, and then actually replaces the ECU after receiving the ECU. Therefore, in the course of ECU replacement, a vehicle maker prepares a part number list that covers all of the vehicle types and specifications, a part supplier supplies supplemental ECUs respectively having vehicle information that is designed to cover each of all the vehicle types and specifications in the list based on inventory, and the dealer receives a specific ECU by placing an order based on the part number list.

However, when replacing the ECU with a new one, a mistake of the software portion of the ECU is hard to be identified, in comparison to a mistake of the hardware portion. That is, the mistake of the software portion, such as a misplacement of the software or the like, can only be found after mounting the ECU on a vehicle and conducting a detailed test. Therefore, when the part number of the ECU is mis-ordered or the ECU has different vehicle information written therein, the replaced ECU may cause malfunction of the vehicle or un-conformity of the vehicle to the regulation of the destination country. Further, the part number management of the ECU is a burden for the part supplier and the vehicle maker, due to a huge number of specifications, vehicle types and destination countries.

### SUMMARY OF THE INVENTION

In view of the above and other problems, the present disclosure discloses a vehicle information writing tool and a vehicle information writing system that appropriately handle a number of different supplemental ECUs, especially for preventing mis-replacement of an ECU and/or mis-writing of vehicle information on an ECU.

In an aspect of the present invention, the vehicle information writing tool used in connection to a vehicle connector of a vehicle side control unit is disclosed. The information writing tool basically includes (i) a main controller with two components of (a) a vehicle memory that stores vehicle information in a non-volatile memory unit and (b) a microprocessor that performs, by referring to the vehicle information, a control process for controlling a vehicular electric device in a vehicle, (ii) the vehicle connector that detachably connects the information writing tool for writing the vehicle information in the vehicle memory, and (iii) a memory writing unit that writes the vehicle information transferred from the information writing tool to the vehicle memory. Further, the information writing tool includes: a tool memory for storing the vehicle information; a tool connector for detachably connecting the vehicle connector to transfer the vehicle information to the vehicle memory; an attachment detector for detecting the attachment of the tool connector to the vehicle connector; and an information transfer control unit for starting a transfer process of the vehicle information from the tool memory to the vehicle memory. Further, the vehicle information representative of one vehicle type has variations respectively corresponding to different vehicle specifications of multiple shipping destinations, and the tool memory stores a portion of the variations of the vehicle information of one vehicle type corresponding to the vehicle specifications of one shipping destination.

In addition, the vehicle information writing system of the present disclosure includes: multiple pieces of the information writing tool of described above for storing the vehicle information respectively corresponding to the different shipping destinations; and the vehicle side control unit for providing (i) the main controller with two components of (a) the vehicle memory that stores the vehicle information specific to each vehicle specification in the non-volatile memory unit and (b) the microprocessor that performs, by referring to the vehicle information, a control process for controlling a vehicular electric device in the vehicle, (ii) the vehicle connector that exclusively allows connection of some of the multiple information writing tools corresponding to intended vehicle specifications via the tool connector disposed thereon, and (iii) the memory writing unit that writes the vehicle information transferred from the information writing tool to the vehicle memory.

According to the vehicle information writing tool/system of the present disclosure, the electric control unit (ECU), which is going to be replaced or repaired, has the vehicle connector, and the ECU is paired with the vehicle information writing tool that has the tool connector having a one-to-one relation to a corresponding vehicle specification. As described above, contents of the vehicle specification in the vehicle side control unit (i.e., the ECU) vary depending on the vehicle type, and even in the same vehicle type, there are variations of specifications depending on the various shipping destinations. Therefore, the vehicle information writing tool exclusively stores, in its non-volatile memory, the specific vehicle information corresponding to one of the various shipping destinations. Thus, the vehicle information writing tool having the tool connector is connected to the vehicle connector, and the vehicle information in the writing tool is retrieved from the memory to be written to the vehicle memory in the ECU, when attachment of the tool connector to the vehicle connector is detected.

The following advantageous effects are achieved in the above operation scheme. That is:

(1) The vehicle information specific to each vehicle is transferred from the tool to the vehicle side control unit for writing information, thereby enabling an inventory control free ECU delivery scheme, due to the on-demand information transfer and writing to the ECU at the time of replacement/repair. This operation scheme reduces the inventory control of various kinds of ECUs, which are otherwise required for the preparation and storage of different ECUs for respective shipping destinations and various vehicle types.

(2) When the vehicle side control unit installed in the vehicle is replaced with the supplemental control unit that does not yet have the vehicle information written in the vehicle memory, the vehicle information is legitimately written in the memory by selecting the writing tool that corresponds to the intended vehicle specification and by connecting the tool side connector to the vehicle side connector. That is, in other words, the writing tool is prepared for each of the multiple specifications of the same (single) shipping destination of the same (single) vehicle type. The writing tools are then distributed to the dealers in each of the multiple destinations with the vehicle information specific to each of those destinations stored in the tools. Then, the supplemental control unit without the vehicle information written therein can be used for replacing the broken unit, thereby greatly reducing the inventory control efforts by the parts supplier. After the replacement of the hardware (i.e., the control unit), the vehicle information is written from the tool to the control unit, by connecting the tool to the supplemental unit. Therefore, the vehicle side control unit is appropriately performed at the dealer. More practically, the shipping destination specific vehicle information can be securely delivered to the dealers in respective shipping destinations without confusion of different destination information, only by devising destination specific writing tool preparation scheme. In other words, the vehicle information for wrong shipping destination is securely prevented from being written into the control unit at the repair shop in the dealers.

The non-volatile tool memory is configured to store the vehicle information that corresponds to only one vehicle specification from among various types of specifications of a single vehicle type designed to be one shipping destination. Therefore, the writing tool can be prepared in one-to-one correspondence manner to respective vehicle specifications. That is, in other words, the intended vehicle information can be written in the vehicle memory by selecting the writing tool that corresponds to the intended vehicle information. Thus, the mis-writing of the vehicle information to the vehicle memory can be securely prevented.

Further, the vehicle side control unit can be used as the information writing tool, in consideration of the compatibility of their components. That is, the vehicle memory in the vehicle side control unit can serve as the tool memory in the information writing tool, and the main controller in the vehicle side control unit can serve as the tool memory in the information writing tool, provided that the vehicle side control unit includes (i) the main controller with two components of (a) the vehicle memory that stores vehicle information in a non-volatile memory unit and (b) the microprocessor that performs, by referring to the vehicle information, a control process for controlling a vehicular electric device in a vehicle, (ii) the vehicle connector of the vehicle side control unit is connected to the tool connector of the information writing tool that stores the vehicle information of a corresponding vehicle specification, and (iii) the memory writing unit that writes the vehicle information transferred from the information writing tool to the vehicle memory. In addition, the vehicle side control unit additionally has (a) the tool connector that detachably connects the vehicle connector on another vehicle side control unit for transferring the vehicle information to the vehicle memory of the another vehicle side control unit, and (b) the attachment detector for detecting the attachment of the vehicle connector to the tool connector. That is, in other words, the vehicle side control unit is formed as the control unit having the writing tool function attached thereto, by the addition of the above two components, that is, the tool connector and the attachment detector. More practically, the tool memory and the information transfer control unit in the writing tool is readily provided as the vehicle memory and the main controller in the vehicle side control unit, and the vehicle memory stores the relevant vehicle information that is used to execute a vehicular device control process. Therefore, the vehicle side control unit can practically serve as the information writing tool by adding the tool side connector and the attachment detector and by using the main controller as the information transfer control unit. Therefore, the information writing tool does not have to be designed and developed from scratch, by only reserving one of the vehicle side control unit as the information writing tool.

### BRIEF DESCRIPTION OF THE DRAWINGS

Objects, features, and advantages of the present disclosure will become more apparent from the following detailed description made with reference to the accompanying drawings, in which:

FIG. 1 is a front/top/back view of a vehicle information writing tool of the present disclosure;

FIG. 2 is an exploded view of a modification of the vehicle information writing tool of the present disclosure;

FIG. 3 is an exploded view of another modification of the vehicle information writing tool of the present disclosure;

FIG. 4 is an illustration of combination of the vehicle information writing tools;

FIG. 5 is an illustration of an outline operation scheme of a vehicle information writing system;

FIG. 6 is an illustration of communication conditions displayed on a display unit of a connector;

FIG. 7 is a block diagram of the vehicle information writing tool in an exemplary configuration;

FIG. 8 is a block diagram of a vehicle side control unit in an exemplary configuration;

FIG. 9 is a flowchart of a detailed operation scheme of the vehicle information writing system;

FIG. 10 is a flowchart of another detailed operation scheme of the vehicle information writing system;

FIG. 11 is a block diagram of the vehicle information writing tools in another exemplary configuration;

FIG. 12 is a block diagram of a vehicle side control unit having the vehicle information wiring tool in an exemplary configuration; and

FIG. 13 is a block diagram of an example of an ID set unit of the vehicle side control unit.

### DETAILED DESCRIPTION

Embodiments of the present disclosure are described with reference to the drawings in the following.

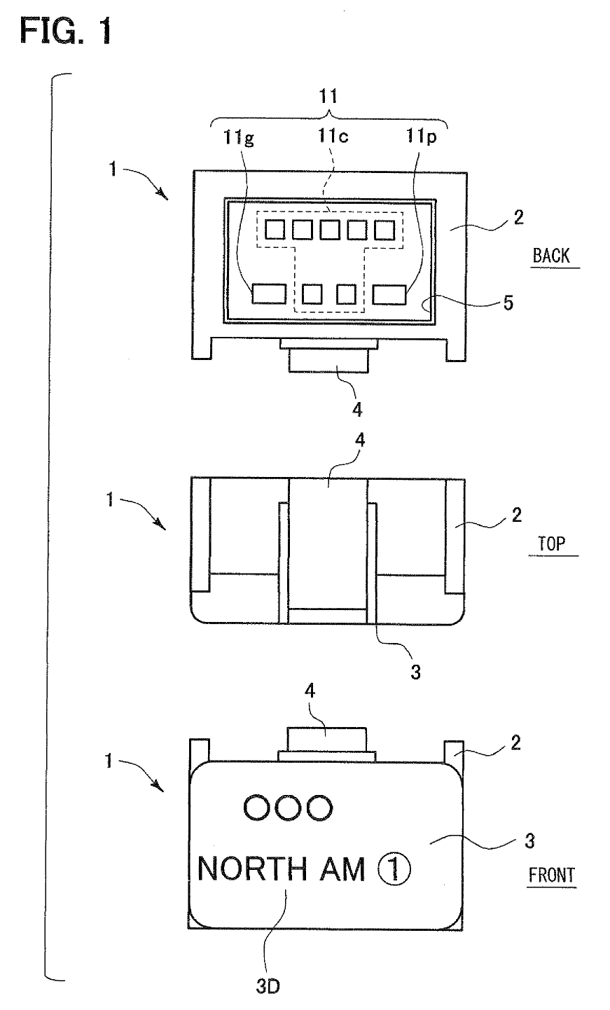

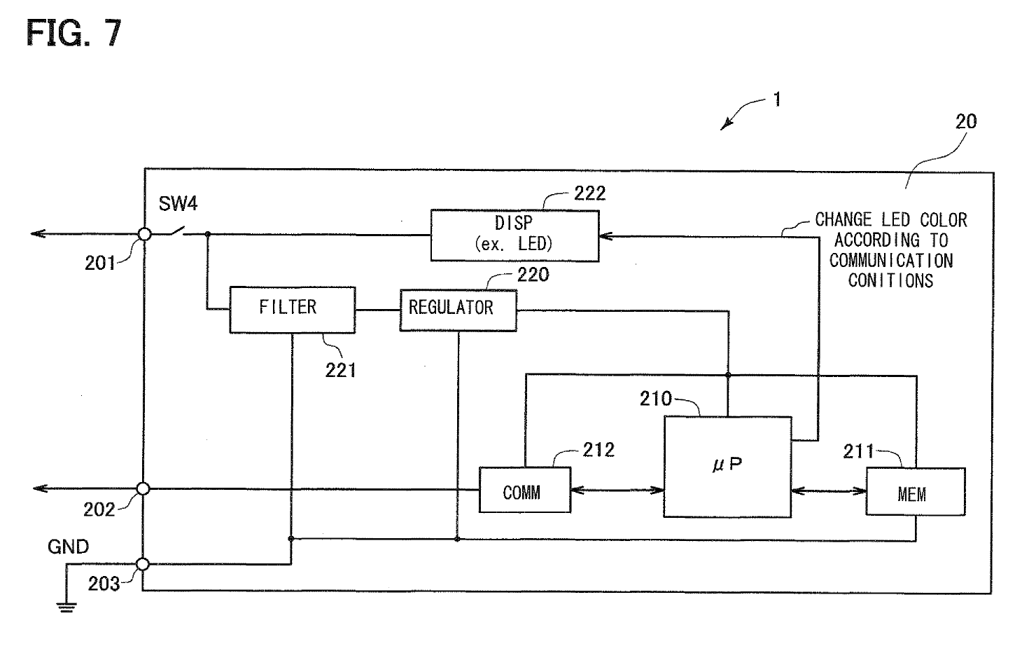

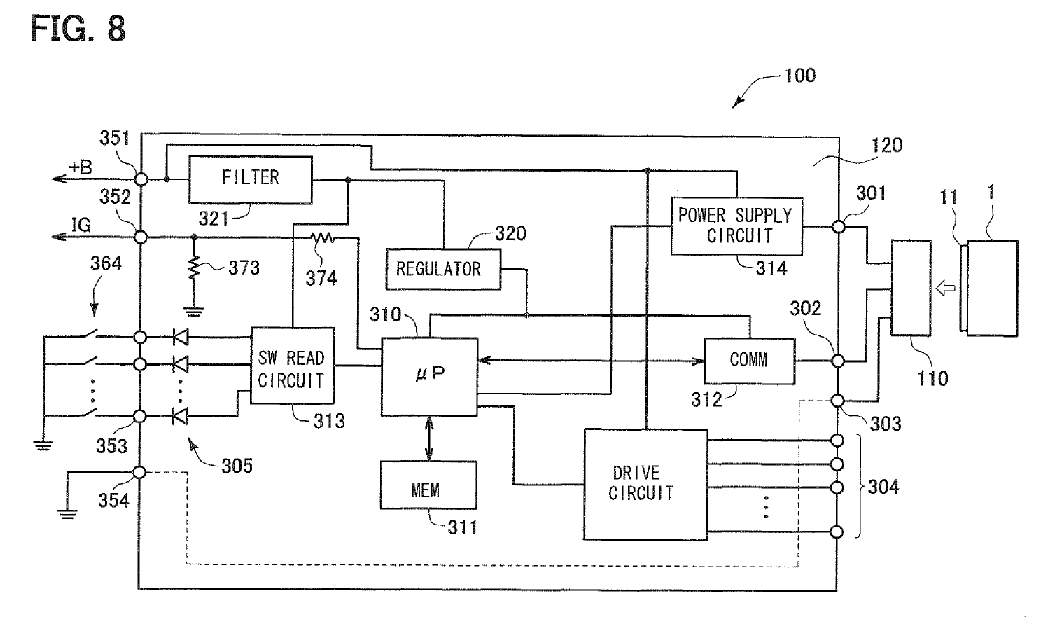

FIG. 1 is an external view of an example of a vehicle information writing tool of the present disclosure. FIG. 7 is a block diagram of the vehicle information writing tool showing an exemplary configuration of its electric components. FIG. 8 is a block diagram of a vehicle side control unit (i.e., an ECU) in an exemplary configuration. The ECU, or a vehicle side control unit 100 in FIG. 8, is connected to a vehicle information writing tool 1 shown in FIG. 7.

The vehicle side control unit 100 in FIG. 8 has a vehicle side nonvolatile memory 311 for storing vehicle information that is specific to each of the various vehicle specifications, a main controller 310 having a microprocessor for executing control processes of vehicular electric devices by referring to the vehicle information, and a vehicle side connector 110 that detachably connects the vehicle information writing tool 1 when vehicle information is written in the vehicle side nonvolatile memory 311. The main controller 310 serves as a memory writing unit for writing the vehicle information in the vehicle side nonvolatile memory 311 when the vehicle information is transferred from the writing tool 1 through the connector 110.

As shown in FIG. 7, the writing tool 1 is configured as an information writing tool 1 that is used in a connected condition to the vehicle side connector 110. More practically, the writing tool 1 has (i) a tool side nonvolatile memory 211 that stores the vehicle information specific to only one shipping destination from among various versions of vehicle information respectively prepared for each of the specifications corresponding to the different shipping destinations of a certain vehicle type, (ii) a tool side connector 11 that detachably connects the vehicle side connector 110 for the transfer of the vehicle information to the vehicle side nonvolatile memory 311, (iii) a connection detection switch SW4 that is, as a connector attachment detection unit, switched for detecting attachment of the vehicle side connector 110 to the tool side connector 11 when the tool side connector 11 is attached to the vehicle side connector 110, and (iv) an information transfer control unit 210 for starting a transfer process of written information in the tool side nonvolatile memory 211 to the vehicle side nonvolatile memory 311 upon detecting the attachment of the tool side connector 11 to the vehicle side connector 110. The tool side nonvolatile memory 211 and the information transfer control unit 210 are implemented on a circuit board 20. As shown in FIG. 1, the writing tool 1 has a tool housing 2 that houses the above circuit board 20, and the tool side connector 11 connected to the circuit board 20 is integrally disposed on an outer face of the tool housing 2

As for the information transfer control unit 210 of the vehicle information writing tool 1, the electric power is supplied from the vehicle side through the tool side connector 11 and the vehicle side connector 110. That is, as shown in FIG. 8, the vehicle side control unit 100 has a power supply circuit 314 for supplying an electric power caused by a battery voltage of a vehicle battery to a power terminal of the vehicle side connector 110.

In addition, as shown in FIG. 7, the vehicle information writing tool 1 has a tool side communication circuit 212 to be connected to the tool side connector 11. The information transfer control unit 210 transfers the vehicle information to the vehicle side control unit 100 through the tool side communication circuit 212. Further, as shown in FIG. 8, a vehicle side communication circuit 312 to be connected to the vehicle side connector 110 is disposed on the vehicle side control unit 100, enabling the vehicle information received by the vehicle side communication circuit 312 to be written in the vehicle side nonvolatile memory 311.

In FIG. 7, the above-mentioned tool side nonvolatile memory 211 and the tool side communication circuit 212 are connected to the information transfer control unit 210 of the vehicle information writing tool 1. The tool side nonvolatile memory 211 may be implemented as a read-only memory (ROM) if the contents of the vehicle information are not changed, for example. On the other hand, if the contents of the vehicle information are changed, the memory 211 may be implemented as an EEPROM, a flash memory or the like. The tool side communication circuit 212 is implemented as an interface IC of a vehicular communication bus (e.g., as a CAN bus or a LIN bus), and is connected to a tool communication terminal 202. Though the tool communication terminal 202 is simplified in FIG. 7, the terminal 202 has multiple pins disposed thereon for compliance to the relevant communication standard.

The above-described components, that is, the information transfer control unit 210, the tool side nonvolatile memory 211, and the tool side communication circuit 212 respectively receives an electric power from a regulator IC 220 that serves as a power circuit implemented on the circuit board 20. The input of the regulator IC 220 is connected to a tool power supply terminal 201 through the above-mentioned detection switch SW4 and a noise filter 221. Further, the ground of each of the circuit elements is unified to be connected to a ground terminal 203 of the tool 1 as shown in FIG. 7.

As already described with reference to FIG. 1, the tool side connector 11 has, in a cylindrical socket 5 disposed on one side of the housing 2 having a rectangular parallelepiped shape, a power terminal pin 11p, a ground terminal pint 11g, and multiple communication terminal pins 11c. The power terminal pin 11p is connected to the tool power supply terminal 201, the ground terminal pin 11g is connected to the tool ground terminal 203, and the multiple communication terminal pins 11c are connected to the tool communication terminal 202. Further, a switch portion of the connection detection switch SW4 is disposed on an outer face of the housing 2 in a protruding manner, for detecting the connection of the tool side connector 11 on the vehicle side connector 110. That is, when the switch portion of the connection detection switch SW4 is pressed by the vehicle side connector 110, the connection detection switch SW4 is turned on. On the other hand, when the tool side connector 11 is pulled out from the vehicle side connector 110, a pressing force applied to the switch portion of the connection detection switch SW4 is released, thereby turning off the connection detection switch SW4.

The vehicle information writing tool 1 has a communication condition indicator 222 for displaying a communication condition with the vehicle side control unit 100 as shown in FIG. 7. That is, the indicator 222 changes its color, for example, according to the communication condition. The indicator 222 is controlled by communication condition information from the vehicle side communication circuit 312 in FIG. 8. The communication condition information is received by the tool side communication circuit 212, and the contents of the communication condition information are reflected to a display condition of the indicator 222 under control of the information transfer control unit 210. That is, for example, the color of the indicator 222 is changed according to the communication condition information.

The communication condition indicator 222 is, in the present embodiment, formed by using light emitting diodes (LEDs), which can change their color, for the purpose of indicating the communication conditions in different colors. As shown in FIG. 1, the tool hosing 2 has a transparent portion 3, and the transparent portion 3 lets the light from the LED of the indicator 222 go therethrough. The transparent portion 3 has a marking 3D that specifies a vehicle type and/or a shipping destination handled by the vehicle information writing tool 1 represented by text as shown in FIG. 1. In the present embodiment, the text of the marking 3D is formed by using a transparent material, with its surroundings formed by using non-transparent material, thereby making the text marking stand out from the surroundings in a color of the LED, which reflects the communication condition between the writing tool 1 and the vehicle side control unit 100. The indicator 222 may be formed by using a dot-matrix display, a 7-segment LED display, or other type of displays. That is, as far as being capable of displaying the communication condition by using text, numerical figures, icons or the like, the indicator 222 may be formed by using any type of display device.

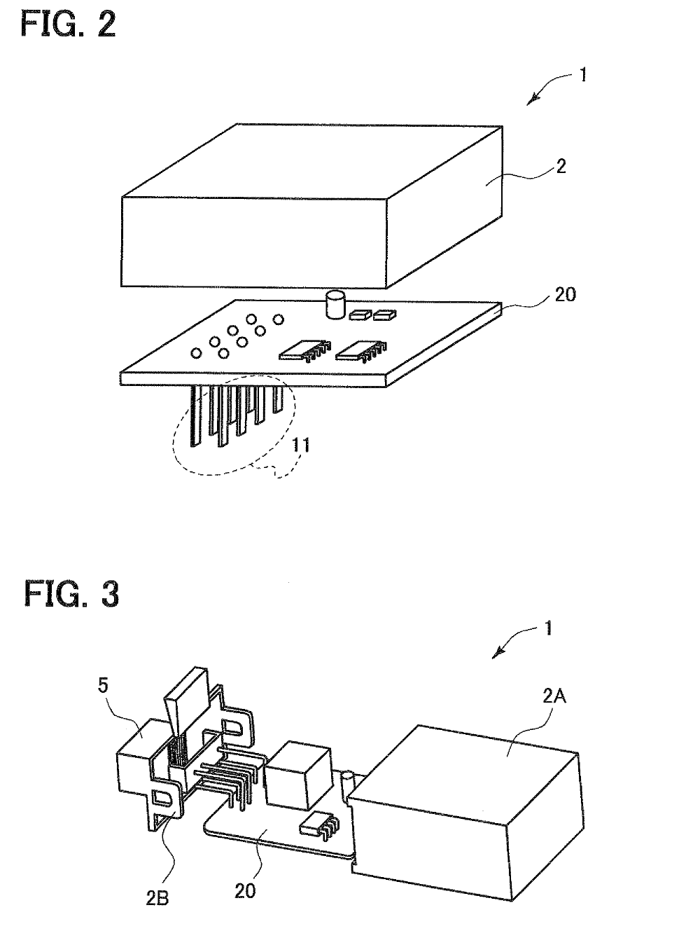

FIG. 2 is a modification of the connector 1, in which an opening of the tool housing 2 is closed by the circuit board 20. That is, the circuit board 20 serves as a cover wall of the opening of the tool housing 2. The tool side connector 11 is formed as a protrusion from the outside of the board 20. Further, FIG. 3 shows another modification of the connector 1. That is, a socket portion 5 of the connector 1 is integrally formed with the circuit board 20, to be serving as a lid 2B of an opening of the housing 2. When the circuit board 20 is inserted into a body 2A of the housing 2 from the opening, the lid 2B is engaged with the body 2A.

The vehicle side control unit 100 in FIG. 8 has the vehicle side nonvolatile memory 311, the vehicle side communication circuit 312, a load drive circuit (i.e., a driver circuit of in-vehicle electronic devices under control of the ECU) and the switch read circuit 313 disposed on a circuit board 120 for connection to the main controller 310. The above-mentioned vehicle information is memorized, together with control software of the in-vehicle electronic devices, in the vehicle side nonvolatile memory 311, which is composed of an EEPROM, a flash memory, or a one-time ROM. The vehicle side communication circuit 312 is composed of the interface IC of the above-mentioned vehicular communication bus, as is the tool side communication circuit 212, and is connected to a communication terminal 302 in the circuit board 120. The output of the load drive circuit is connected to a load connection terminal 304.

The switch read circuit 313 has a group of switches 364 connected thereto through a switch terminal 353. The group of switches 364 serves as an ID setting unit. The group of switches 364 is formed as a group of DIP switches 364 in the present embodiment. The group of DIP switches 364 is used for setting a vehicle ID that is specific to a certain vehicle type and specification. That is, when one vehicle is shipped to a certain destination having a specification that is suitable to that destination, the vehicle side control unit has a certain vehicle ID that specifies that shipping destination and specification. Thus, the vehicle ID is used to determine that the vehicle information writing tool 1 matches with the designated shipping destination and specification of that vehicle. A diode 305 disposed on each of the inputs of the group of DIP switches 364 is used to prevent a leading-in current from the ground in case of alternation of input polarity of battery voltage +B due to superposition of alternator voltage as well as preventing the input terminals of the switch read circuit 313 from breakage by the static electricity.

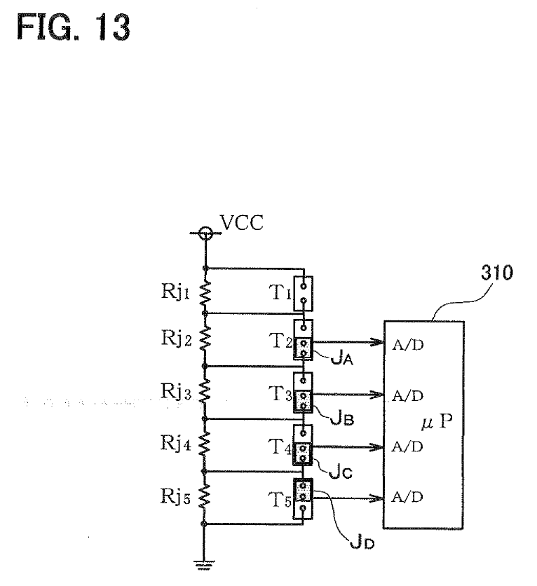

The ID setting unit may have a different configuration from the above-described form that is realized by using the DIP switches. That is, as long as being capable of setting electrically-retrievable information that uniquely corresponds to a certain ID, any mechanism can be used. For example, by utilizing jumper terminal units J1 to J5 between voltage-dividing resistors Rj1 to Rj5 connected in a series to a signal voltage VCC as shown in FIG. 13, the divided voltage of adjacent voltage-dividing points can be distributed to be input to A/D conversion ports of the main controller 310 in a suitable manner for representing a certain ID based on a combination of jumper positions of jumpers JA to JD. In the present embodiment, each of the jumper terminal units J1 to J5 is configured to selectively set a jumper between two adjacent voltage-dividing points, thereby enabling to change the level of the analog input voltage by the amount of one voltage-dividing resistor, depending on the jumper position being on the ground side or the signal voltage VCC side. That is, in other words, the analog input voltage of the A/D conversion ports can be controlled to represent an ON (i.e., one) state and an OFF (i.e., zero) state of a certain digit, for ID coding.

The switch read circuit 313 reads the setting of the DIP switches 364, and generates a vehicle side 1D signal that is input to the main controller 310. On the other hand, the tool side nonvolatile memory 211 of the writing tool 1 in FIG. 7 stores a tool side ID that specifies the vehicle type and specification relevant to the vehicle information in the memory 211. When the writing tool 1 is connected to the vehicle side control unit 100, the tool side ID is transferred to the vehicle side control unit 100, and the vehicle side control unit 100 examines the received tool side ID for determining whether the tool side ID matches the vehicle side ID. If the IDs match with each other, the vehicle side control unit 100 allows the writing tool 1 to transfer the vehicle information. If the IDs do not match, the transfer of the vehicle information is prohibited. The matching examination may be performed on the writing tool side, by transferring the vehicle side ID from the vehicle to the writing tool 1.

The main controller 310, the vehicle side nonvolatile memory 311, the vehicle side communication circuit 312, the switch read circuit 313, and the load drive circuit, respectively receives a power voltage from the regulator ID 320 that serves as a power circuit on the circuit board 120. The input of the regulator IC 320 is connected to a vehicle power supply terminal 351 that receives the battery voltage +B through a noise filter 321 by in-vehicle the pitcher and the catcher. The grounds (not shown in the drawing) of each of the circuit elements are unified, and are connected to a ground terminal 354 that leads to a ground line of a vehicle body. Further, on the vehicle side connector 110 of the circuit board 120, a connector side power terminal 301, a communication terminal 302 and connector side ground terminal 303 are formed, respectively for connection to a power terminal pin, a ground terminal pin and a communication terminal pin of the tool side connector 1 through said the vehicle side connector 110. The connector side ground terminal 303 is connected to the ground terminal 354 through a ground conductor formed on the circuit board 120.

The battery voltage +B input into the vehicle power supply terminal 351 is also distributed to the connector side power terminal 301 through the power supply circuit 314. The power supply circuit 314 is a power switch circuit that switches between supply and shut-off of the battery voltage +B to be supplied to the connector side power terminal 301 in response to an instruction from the main controller 310. On the other hand, to an IG terminal 352 of the circuit board 120, an ignition switch signal from the vehicle side is input through a pull-down resistor 373 and an adjustment resistor 374, toward the main controller 310. The main controller 310 turns on the power supply circuit 314 when the ignition switch signal is input, for supplying the battery voltage +B to the connector side power terminal 301. If the vehicle information writing tool 1 is connected to the vehicle side connector 110 when the circuit 314 is turned on, the battery voltage +B is supplied to the tool power supply terminal 201 of FIG. 7 as the power voltage. Then, the connection detection switch SW4 is turned on at the same time, the battery voltage +B is supplied to the information transfer control unit 210 through the regulator IC 220 the information transfer control unit 210, for enabling the operation of the control unit 210 for information transfer to the vehicle side control unit 100. On the other hand, when the ignition switch signal is not input, the power supply circuit 314 is turned off, and the battery voltage +B is not supplied to the connector side power terminal 301. Thus, the vehicle information writing tool 1 is not operable even if it is connected to the vehicle side connector 110.

Assuming that the vehicle side control unit 100 controls a lighting system of the vehicle, and that an auto lamp-off function for automatically turning off the head lamps and tail lamps (i.e., for preventing inadvertent lamp on at the time of parking) is either recommended or mandated, under the circumstance that “daytime running light” is mandated/recommended in North America (especially in Canada), the fact that, depending on the shipping destination, same type vehicles may have different vehicle information for different function/specification is apparent. Likewise, if the vehicle side control unit 100 controls security related functions or buzzer related function, the vehicle side control unit 100 must accommodate prohibition of an answer-back buzzer function in association with the smart-entry function in some destinations. Therefore, the vehicle information is different depending on the vehicle type and/or vehicle specification that customizes the same vehicle type to specific requirements of the shipping destination.

If the control unit 100 described above has an irreparable trouble, the control unit 100 has to be replaced with a new one. In that case, if the replaced control unit 100 is designed to be shipped to a different destination by mistake, the control unit 100 may allow a function that is prohibited in the shipping destination, or may not comply with the regulation of the shipping destination due to inoperability of the required function.

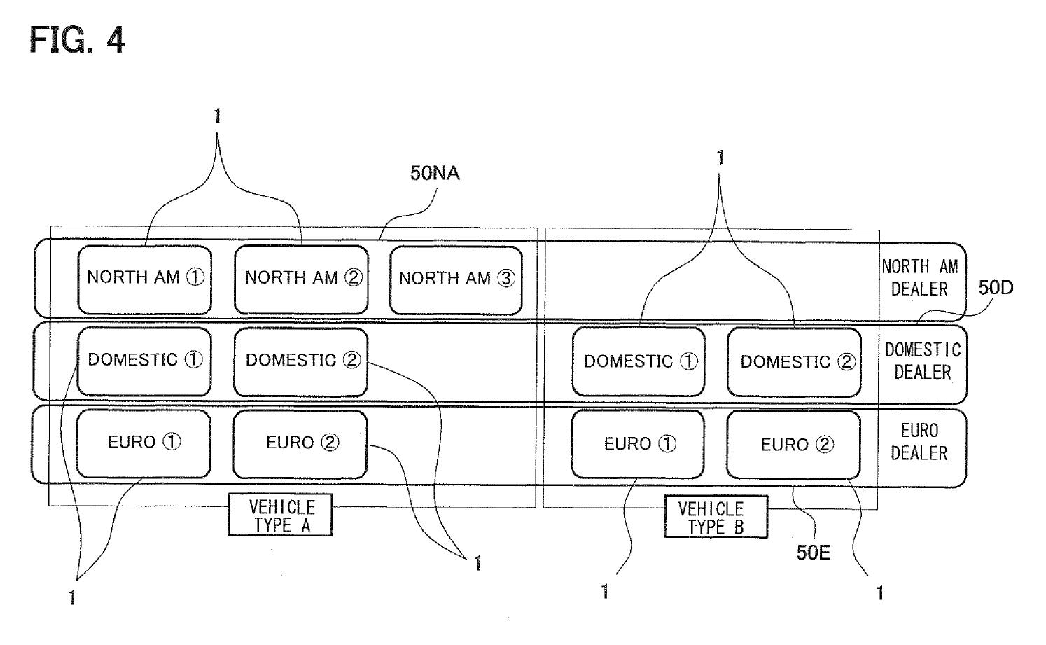

In the present disclosure, as shown in FIG. 4, the vehicle information writing tool 1 is prepared for every one of multiple specifications that are produced as a matrix of multiple vehicle types and multiple shipping destinations. That is, three shipping destinations including North America, Domestic, Europa are multiplied by the two vehicle types A and B to yield six different destination-vehicle type combinations, in which two or three different specifications are respectively arranged, thereby leading to a total of eleven vehicle information writing tools 1, due to the one to one correspondence of the specifications and the writing tool 1. Thus, each of the eleven different writing tools 1 stores respectively different vehicle information in the tool side nonvolatile memory 211 for realizing the intended vehicle specification. The dealers in the respective shipping destinations receive a set of writing tools 1 that include the required vehicle specifications for each of the vehicle types.

When the vehicle that has a broken vehicle side control unit 100 is brought to a dealer, the broken vehicle side control unit 100 causing a trouble is removed, and a supplemental vehicle side control unit that stores, in the vehicle side nonvolatile memory 311, no written-in vehicle information that may differ depending on the shipping destinations for the same vehicle type is installed. Then, the vehicle information writing tool 1 corresponding to the relevant vehicle specification is connected to the vehicle side connector 110, to write the vehicle information in the tool side nonvolatile memory 211 in the vehicle side nonvolatile memory 311 by transferring the information to the supplemental vehicle side control unit. As a result, the vehicle information for the different shipping destination or for the different specification is securely prevented to be written in the memory 311. Further, the supplier of the supplemental vehicle side control units is not required to ship those units by writing the vehicle type/specification specific vehicle information in advance. Thus, the supplier is freed from hassles for preparing vehicle side control units for each of the different vehicle types and specifications, thereby dispense with the inventory control of different ECU products.

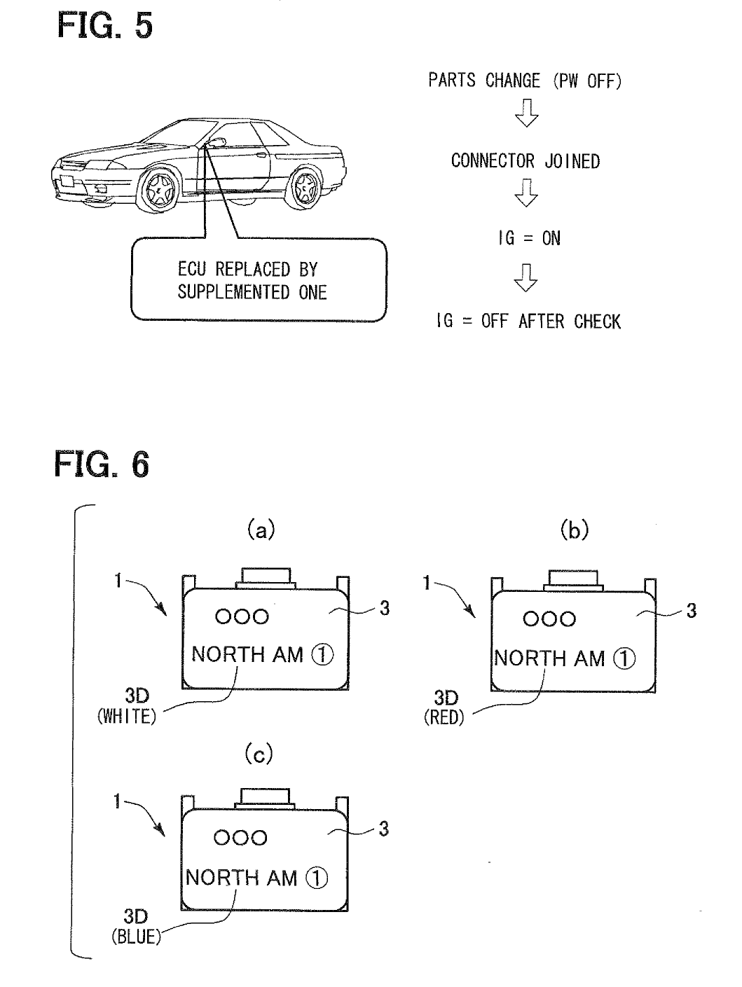

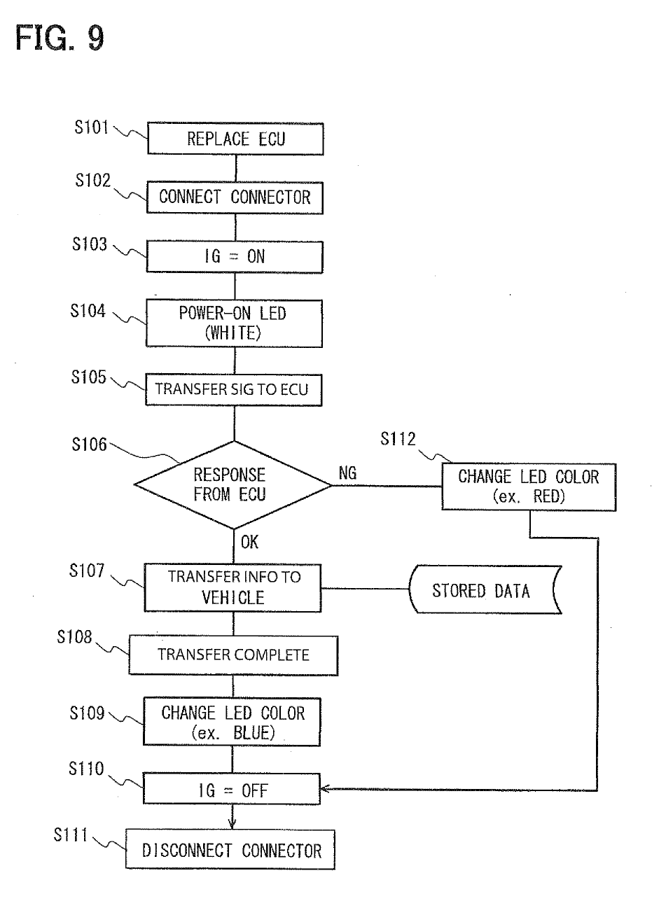

A systematic operation of writing the vehicle information involving the writing tool 1 and the control unit 100 is described with reference to a flowchart in FIG. 9. The illustration in FIG. 5 shows an outline concept of vehicle information writing. In S101, the broken vehicle side control unit is replaced with a supplemental vehicle side control unit (i.e., an ECU), and, in S102, the tool side connector 11 of the vehicle information writing tool 1 is connected to the vehicle side connector 110 of the supplemental vehicle side control unit. Then, if an ignition switch signal is detected in S103 (when an IG switch is turned on), a power supply is provided from the vehicle to the vehicle information writing tool 1 according to the above-mentioned procedure. When the vehicle information writing tool 1 detects the power supply, the writing tool 1 switches the communication condition indicator 222 from a non-lighted condition representing no-power supply to a lighted condition that is shown in FIG. 6 at (a) portion. The color of the LED is, in this case, lighted in white.

Subsequently, the ID matching is performed in the above-described manner. If the writing tool is determined as not-matching, the writing process is concluded without information transfer and writing. On the other hand, when it is determined that the ID is matching and the writing tool is appropriate, the process proceeds to S105 for transferring to the supplemental vehicle side control unit (i.e., an ECU) an inquiry signal that inquires if it is OK to start transferring the vehicle information. If, in S106, a response from the control unit that indicates that the transferring of the vehicle information is OK is received, the process proceeds to S107 and the vehicle information stored in the tool side nonvolatile memory 211 is transferred to the vehicle side. The transferred information is received on the vehicle side, and the information is written in the nonvolatile memory 311 of the supplemental vehicle side control unit. When the transfer of the vehicle information is complete in S108, the process proceeds to S109, and the color of the communication condition indicator 222 is changed to a lighted condition that indicates a normal completion of information transfer (and writing), as shown in FIG. 6 at (c) portion. That is, the LED color is changed to blue. On the other hand, when a response from the supplemental vehicle side control unit indicates that the start of information transfer is not OK in S106, or when the transferred vehicle information is not successfully written, the process proceeds to S112, and the communication condition indicator 222 is changed to a lighted condition that indicates the failure of the information transfer as shown in FIG. 6 at (b) portion. That is, the LED color is changed to red. The communication condition indicator 222 is apparently changing its lighted condition according to the contents of information that reflects communication condition. That is, In other words, the color of the LED indicates the connector condition, or information transfer condition, thereby allowing a mechanic to confirm whether the vehicle information corresponding to a vehicle specification of a specific shipping destination of a certain vehicle type has been written to the ECU.

In either case, if the IG switch is turned off in S116, the power supply to the vehicle information writing tool 1 is shut off, and the communication condition indicator 222 is switched to the non-lighted condition representing no power supply. The user confirms this no power supply condition, for removing the vehicle information writing tool 1 from the vehicle side connector 110.

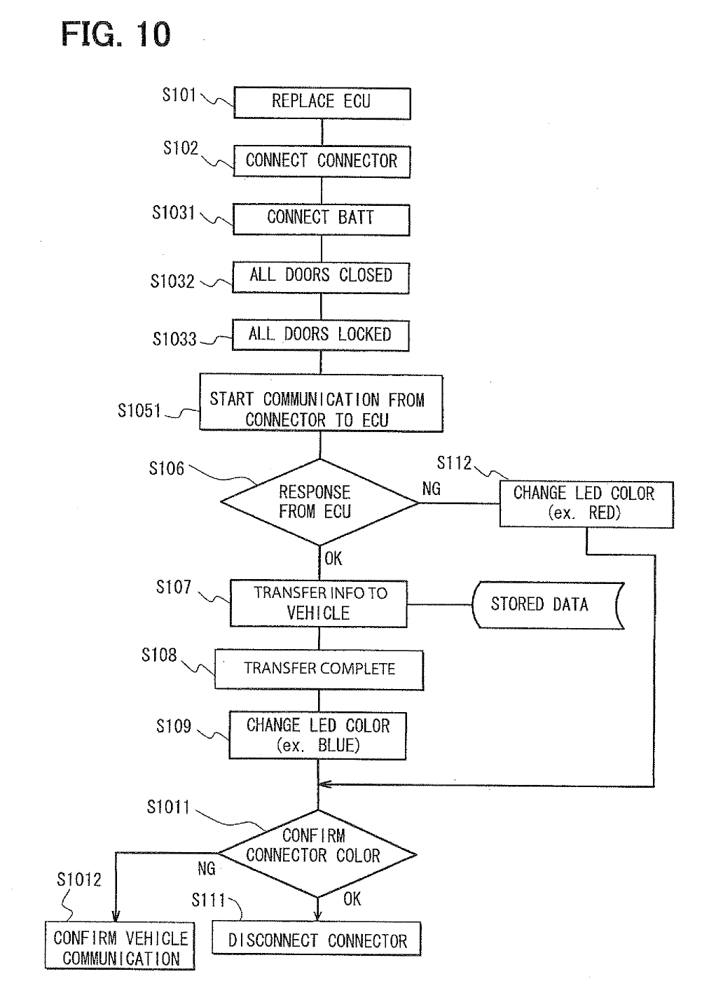

Further, the vehicle information writing tool 1 may be operated without referring to an ignition switch signal. A flowchart in FIG. 10 shows this process. In FIG. 10, like numbers represents like steps, and focus of the following description is put on the difference from FIG. 9. After connecting the writing tool 1 in S102, the power supply is provided from the vehicle side to the vehicle information writing tool 1 regardless of the condition of the ignition switch signal in S1031. In this case, the power supply circuit 314 in FIG. 8 may be omitted and the battery voltage +B may be directly supplied to the connector side power terminal 301. When the battery voltage +B is directly supplied to the terminal 301, the writing tool 1 always has the power supply regardless of the signal condition. Therefore, the communication condition indicator 222 does not have the non-lighted condition indicative of no power supply. That is, in other words, the indicator 222 immediately turns on in the lighted condition in the color of white upon being connected to the vehicle side connector 110.

In S1032, all doors of the vehicle are closed, and, in S1033, all doors of the vehicle are locked. Then, the process proceeds to S1051 to send an inquiry signal from the writing tool 1 to the supplemental vehicle side control unit (i.e., an ECU), inquiring whether starting of transferring the vehicle information is OK. Then, in S106 to S109, the same procedure is taken as FIG. 9. Then, in S1011, after confirming the LED color, the process proceeds to S111 for disconnecting the writing tool 1 from the vehicle side connector 110 if the LED color of the indicator 222 is either blue (=successful transfer) or red (=transfer failure). If the condition of the indicator 222 corresponds none of the above two conditions, it is determined as communication failure, and the contents of the communication failure is determined after proceeding to S1012.

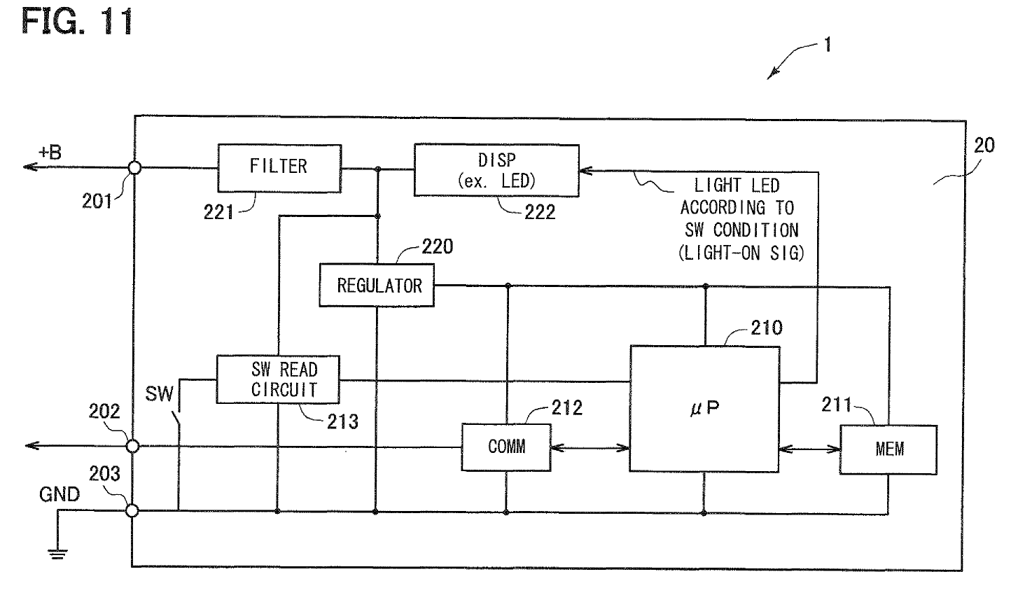

The indicator 222 may be configured to only represent a power voltage supply condition to the information transfer control unit 210 as shown in FIG. 11. In that case, the detection condition of the connection detection switch SW4 is detected by the switch read circuit 213, and the information transfer control unit 210 receives the detection signal from the read circuit 213 for controlling the lighted condition of the indicator 222. In other words, because the indicator 222 is configured to receive the power supply through the tool power supply terminal 201, the indicator 222 is not switched to the lighted condition without the supply of the battery voltage +B to the tool power supply terminal 201, even when the connection detection switch SW4 is turned on,

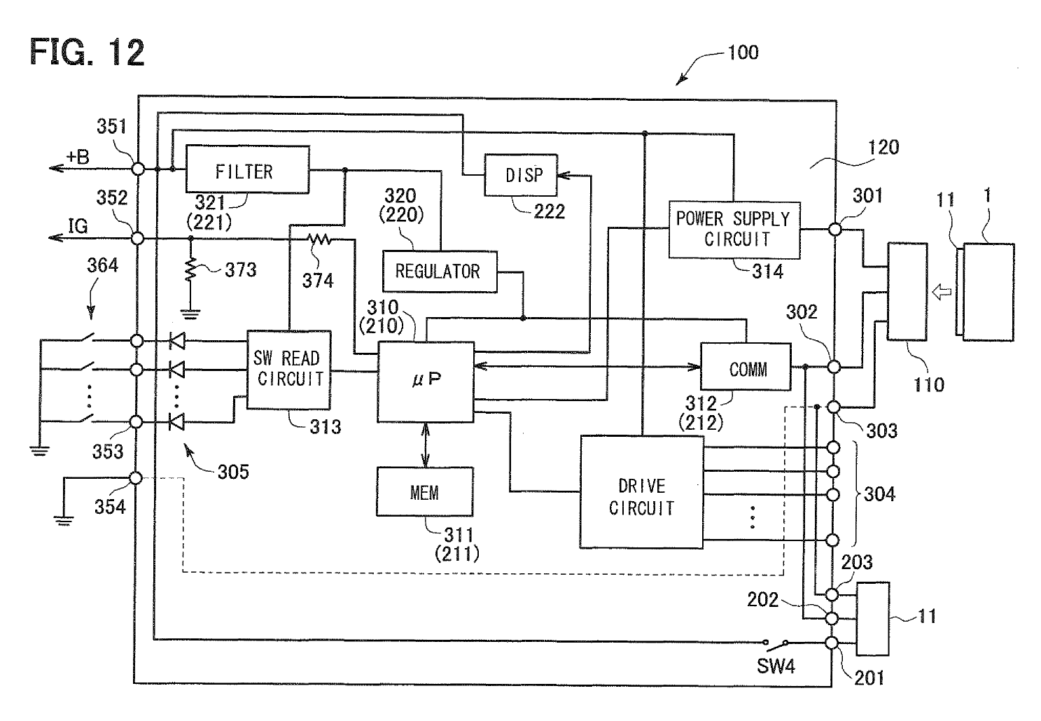

FIG. 12 shows an example of the function of the vehicle information writing tool added to the vehicle side control unit 100 of FIG. 8 (i.e., a tool function added vehicle side control unit). In FIG. 12, the writing tool 1 of FIG. 7 is incorporated to the control unit 100. However, the writing tool 1 of FIG. 11 may be incorporated to the control unit 100. In FIG. 12, the reference numerals in parentheses show correspondence of the components in the control unit 100 to respective components in the writing tool 1 in FIG. 7. More practically, the microprocessor serving as the main controller 310 corresponds the information transfer control unit 210, and the vehicle side nonvolatile memory 311 corresponds to the tool side nonvolatile memory 211, and the vehicle side communication circuit 312 corresponds to the tool side communication circuit 212, respectively. That is, in other words, the components 310, 311, 312 in the control unit 100 respectively provide, besides their original functions, the function of the components 210, 211, 212 of the writing unit 1 in a combined manner. Further, same as in FIG. 7, the communication condition indicator 222, the tool power supply terminal 201, the tool communication terminal 202, the tool ground terminal 203, and the tool side connector 11 are added to FIG. 12. The tool power supply terminal 201 is connected to the vehicle power supply terminal 351 on the circuit board 120, and the connection detection switch SW4 is added to the circuit between the terminal 201 and the switch SW4. Further, the tool ground terminal 203 is connected to the ground terminal 354, and the tool communication terminal 202 is connected to the vehicle side communication circuit 312, respectively.

The vehicle side nonvolatile memory 311 has a control program for controlling the vehicle information transfer and display of the communication condition indicator 222 added thereto. The main controller 310 executes the control program for transferring the vehicle information in the memory 311 to the supplemental vehicle side control unit according to the process described in FIGS. 9 and 10 while the tool side connector 11 is connected to the vehicle side connector 110 of the supplemental vehicle side control unit. The vehicle information in the vehicle side nonvolatile memory 311 is used by the vehicle side control unit 100 in FIG. 12 for controlling the vehicular electric devices. Therefore, the vehicle information in the nonvolatile memory 311 specifies only the relevant vehicle type and relevant vehicle specification. Thus, the vehicle side control unit 100 can only be used as the vehicle information writing tool for the supplemental vehicle side control unit that matches the relevant vehicle type/specification. In this case, the vehicle side ID uniquely set by the DIP switches 364 on the vehicle side control unit 100 that serves as the writing tool is considered as the tool side ID, and is compared with the vehicle side ID in the supplemental vehicle side control unit that is going to have the vehicle information written therein. When the ID is matching, the transfer of the vehicle information is allowed, and, when the ID is not matching, the transfer of the vehicle information is prohibited.

Such changes, modifications, and summarized schemes are to be understood as being within the scope of the present disclosure as defined by appended claims.

What is claimed is:

1. An information writing tool used in connection to a vehicle connector of a vehicle side control unit, the vehicle side control unit includes (i) a main controller with two components of (a) a vehicle memory that stores vehicle information in a non-volatile memory unit and (b) a microprocessor that performs, by referring to the vehicle information, a control process for controlling a vehicular electric device in a vehicle, (ii) the vehicle connector that detachably connects the information writing tool for writing the vehicle information in the vehicle memory, and (iii) a memory writing unit that writes the vehicle information transferred from the information writing tool to the vehicle memory, the information writing tool comprising:
a tool memory for storing the vehicle information in a non-volatile memory unit;
a tool connector for detachably connecting the vehicle connector to transfer the vehicle information to the vehicle memory;
an attachment detector for detecting the attachment of the tool connector to the vehicle connector; and
an information transfer control unit for starting a transfer process of the vehicle information from the tool memory to the vehicle memory upon detecting the attachment of the tool connector to the vehicle connector,
wherein the vehicle information representative of one vehicle type has variations respectively corresponding to different vehicle specifications of multiple shipping destinations, and
the tool memory stores a portion of the variations of the vehicle information of one vehicle type corresponding to the vehicle specifications of one shipping destination.

2. The information writing tool of claim 1, wherein
the tool memory stores the vehicle information representative of only one vehicle specification from among the variations of the vehicle information representative of the multiple vehicle specifications for one shipping destination.

3. The information writing tool of claim 1 further comprising:
a tool housing for housing a circuit board that bears the tool memory and the information transfer control unit implemented thereon, wherein
a marker indicative of both of a vehicle type and a shipping destination is positioned to be visible from outside of the tool housing for the marking of information writing tool specific to the vehicle type and the shipping destination.

4. The information writing tool of claim 3, wherein
the tool housing has one piece of the tool connector on an outer face for connection to the circuit board.

5. The information writing tool of claim 1, wherein
the attachment detector has an attachment detection switch that is switched by the attachment of the tool connector to the vehicle connector.

6. The information writing tool of claim 1, wherein
the information transfer control unit has a power supply from the vehicle through the tool connector and the vehicle connector.

7. The information writing tool of claim 6, wherein
the attachment detector detects the attachment of the tool connector to the vehicle connector depending on whether the information transfer control unit is having the power supply or not.

8. The information writing tool of claim 6 further comprising:
a power indicator for indicating a condition of the power supply to the information transfer control unit.

9. The information writing tool of claim 1 further comprising:
a tool side communication circuit that is in connection to the tool connector, wherein
the information transfer control unit transfers the vehicle information to the vehicle side control unit through the tool side communication circuit.

10. The information writing tool of claim 9 further comprising:
a communication indicator for indicating a condition of the communication to the vehicle side control unit, wherein
the communication indicator changes its display condition according to the condition of the communication to the vehicle side control unit.

11. The information writing tool of claim 10,
wherein the communication indicator changes its display condition according to a transfer result of the vehicle information to the vehicle side control unit.

12. The information writing tool of claim 1, wherein
the information writing tool is capable of serving as the vehicle side control unit,
the vehicle side connector of the vehicle side control unit is connected to the tool side connector of the information writing tool that stores the vehicle information of a corresponding vehicle specification,
the vehicle side control unit allows (a) the vehicle memory to act as the tool memory, and allows (b) the main controller to act as the information transfer control unit, and
the vehicle side control unit additionally has (a) the tool connector that detachably connects the vehicle connector on another vehicle side control unit for transferring the vehicle information to the vehicle memory of the another vehicle side control unit, and (b) the attachment detector for detecting the attachment of the vehicle connector to the tool connector.

13. An information writing system comprising:
multiple pieces of the information writing tool of claim 1 for storing the vehicle information respectively corresponding to the different shipping destinations; and
the vehicle side control unit for providing (i) the main controller with two components of (a) the vehicle memory that stores the vehicle information specific to each vehicle specification in the non-volatile memory unit and (b) the microprocessor that performs, by referring to the vehicle information, a control process for controlling a vehicular electric device in the vehicle, (ii) the vehicle connector that exclusively allows connection of some of the multiple information writing tools corresponding to intended vehicle specifications via the tool connector disposed thereon, and (iii) the memory writing unit that writes the vehicle information transferred from the information writing tool to the vehicle memory.

14. The information writing system of claim 13, wherein
the multiple pieces of the information writing tool corresponds to multiple vehicle specifications of one shipping destination of one vehicle type.

15. The information writing system of claim 13, wherein,
when one vehicle side control unit is replaced with a supplemental vehicle side control unit of the same hardware specification with its vehicle memory having no vehicle information written therein, the vehicle information is written in the vehicle memory after selectively connecting the information writing tool that corresponds to an intended vehicle specification to the vehicle connector of the supplemental vehicle side control unit.

16. The information writing system of claim 13, wherein
a tool matching detector is disposed on one of the information writing tool or the vehicle side control unit for determining the matching of the information writing tool to the vehicle side control unit, and
the information transfer control unit of the information writing tool transfers the vehicle information to the vehicle side control unit only when the information writing tool matches the vehicle side control unit.

17. The information writing system of claim 13, wherein
the information transfer control unit of the information writing tool has a power supply from the vehicle through the tool connector and the vehicle connector,
the vehicle side control unit includes:
a power supply circuit for supplying a power voltage from a vehicle battery to a power terminal of the vehicle connector;
an ignition switch signal detector for detecting a signal from an ignition switch of the vehicle; and
a power controller for starting supply of the power voltage to the power circuit upon detection of the ignition switch signal.

18. The information writing system of claim 13, wherein
the information writing tool has a communication indicator that changes its display condition according to the condition of the communication to the vehicle side control unit,
the vehicle side control unit has a vehicle side communication circuit to be connected to the vehicle connector, and
the memory writing unit writes the vehicle information received by the vehicle side communication circuit in the vehicle memory.

19. The information writing system of claim 18, wherein
the information writing tool has a communication indicator that changes its display condition according to the condition of the communication to the vehicle side control unit,
the vehicle side communication circuit transfers communication condition information that reflects a communication condition of the vehicle side control unit, and
the communication indicator of the information writing tool changes its display condition according to a reception result of the communication condition information.

20. The information writing system of claim 18, wherein
the vehicle side control unit starts reception of the vehicle information from the information writing tool when it has a connection to the information writing tool and when it detects the ignition switch signal.

21. The information writing system of claim 18, wherein
the vehicle side control unit starts reception of the vehicle information from the information writing tool when it has a connection to the information writing tool and when it detects an all doors locked condition of the vehicle.
